(19) United States
(12) Patent Application Publication
(10) Pub. No.: US 2004/0107919 A1
(43) Pub. Date: Jun. 10, 2004

(54) Original doggy bar

(76) Inventor: Gabriel Browne, Indianapolis, IN (US)

Correspondence Address: GDB, Attn: Gabriel Browne, P.O. Box 30583, Indianapolis, IN, 46230, US

(21) Appl. No.: 10/648,892

(22) Filed: Aug. 27, 2003

Related U.S. Application Data
(60) Provisional application No. 60/406,235, filed on Aug. 28, 2002.

(51) Int. Cl. A01K 27/00

(52) U.S. Cl. 119/769

(57) ABSTRACT

The present invention includes a pet-securing device that can be affixed to a horizontal or vertical surface such as a wall or floor. The invention includes a base, a bar, and accessories that allow multiple animals, such as dogs, to be secured to the pet securing device.

### CROSS REFERENCE TO RELATED APPLICATIONS

This application claims the benefit of U.S. Provisional Application No. 60/406,235, filed Aug. 28, 2002.

### BACKGROUND AND SUMMARY OF THE INVENTION

This invention relates to pet securing devices, which allow pet owners to tie or affix their pets to a stationary object and allow freedom of movement for the pet owner.

Other pet securing devices that have preceded the present invention include, but are not limited to, stakes, augers, chains, augers with loops, and augurs with retractable leashes.

Still the closest prior art for this type of application is not used for residential pets but for horses. Horses for centuries have had locations where patrons could arrive and tie up their horse. However, horses no longer are the predominant transportation method, therefore, securing areas for horse travelers is not in demand. Vice versa, pet owners frequently travel with their pets making the need for securing area station a paramount.

U.S. Pat. No. 6,401,656 to Adkisson discloses an auger shaft that is placed in the ground and has arms attached to the auger for placing food, water, and a place for an umbrella. U.S. Pat. No. 5,787,842 to Shmoldas discloses a pet securing system/leash which restricts pets from passing through various entryways and to minimize pets desire to aggravate injured body parts. U.S. Pat. No. 5,482,246 to Derkoski discloses an auger for positioning or placing a post into the earth. U.S. Pat. No. 2,776,644 to Fontaine discloses a tethering device, which allows an individual to secure a device around the wrist that has a spooling device for a leash.

The pet securing device of the present invention allows for efficient and logical means for tethering a pet.

One goal of the present invention is to allow individuals freedom to travel with their pets to areas where they would not have prior to this invention. Furthermore, an additional objective of the present invention is to provide a secure place for pet owners to secure their pets in various places with easy accessibility. Examples of desired locations for securing pet are malls, sidewalks, streets, restaurants, apartments, homes, businesses, mobile homes, and RV's.

Another objective of the present invention is to allow individuals the opportunity to have a permanent pet securing device that is reliable, attractive, and has the ability to be affixed or removed from various locations with limited effort.

Another objective of the present invention is to provide a variation of a retractable leash that is built into the invention's bar that allows pet owners to attach their pet to the retractable leash which is mounted on the stationary bar.

### BRIEF DESCRIPTION OF THE DRAWINGS

FIG. 1 is a profile view of an embodiment of the pet securing device.

FIG. 2 is a front view of components of one embodiment of the pet securing device.

FIG. 3a is a top view of components of one embodiment of the pet securing device.

FIG. 3b is a profile view of components of one embodiment of the pet securing device.

FIG. 3c is a profile view of components of one embodiment of the pet securing device.

FIG. 4 is a profile view of one embodiment of the pet securing device.

FIG. 5 is a top view of components of one embodiment of the pet securing device.

### DETAILED DESCRIPTION OF THE DRAWING

The embodiments described below and shown in the figures are merely exemplary and are not intended to limit the invention to the precise forms disclosed. Instead, the embodiments were selected for description to enable one of ordinary skill in the art to practice the invention.

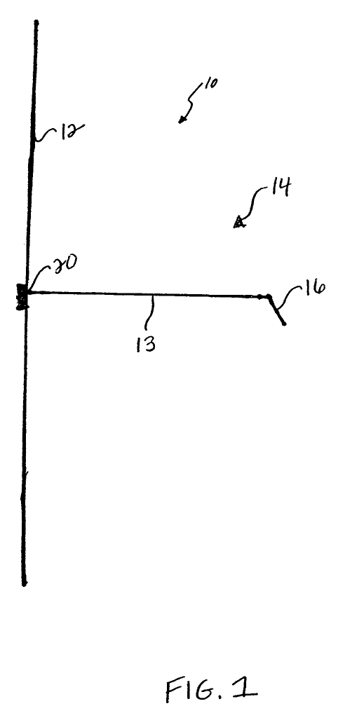

Referring to FIGS. 1-3B, a pet security device 10 that is attached to walls is shown. Specifically, 12 is a solid piece of metal that is used as the base to secure the pet securing device 10 to a wall, 14 is a bar with two ninety degree angles with a straight piece 4 in the middle of the two ninety degree angles and two legs 13 which anchor to the solid piece of metal 12. Piece 4 has a curved/bent middle section between the two legs 13 which anchor to the piece of metal 12 which allow installers to place anchoring screws between the two legs 13 and install the pet securing device 10 to a wall/floor. Reference numeral 22 is approximately where the holes for the screws are located.

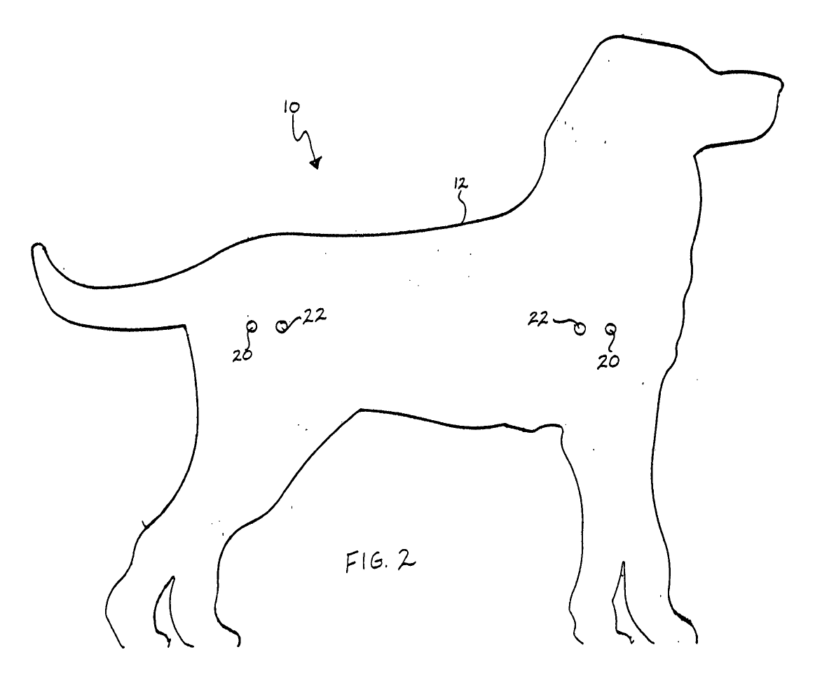

FIG. 2 is a silhouette of a dog used as part of the pet securing device 10. Holes 20 in the base secure the bar 14 where dogs may be tied up. The bar 14 is secured to holes 20 as shown in FIG. 1. Holes 20 are where the bar 14 is attached to piece of metal 12. The holes 20 are used to securely combine the bar 14 and the piece of metal 12 together so that the pet securing device 10 becomes one unit. Reference numeral 22 are the holes used by screws to attach the pet securing device 10 to a wall or floor. Piece of metal 12, which is a silhouette of a dog, has different variations of pet silhouettes in different models.

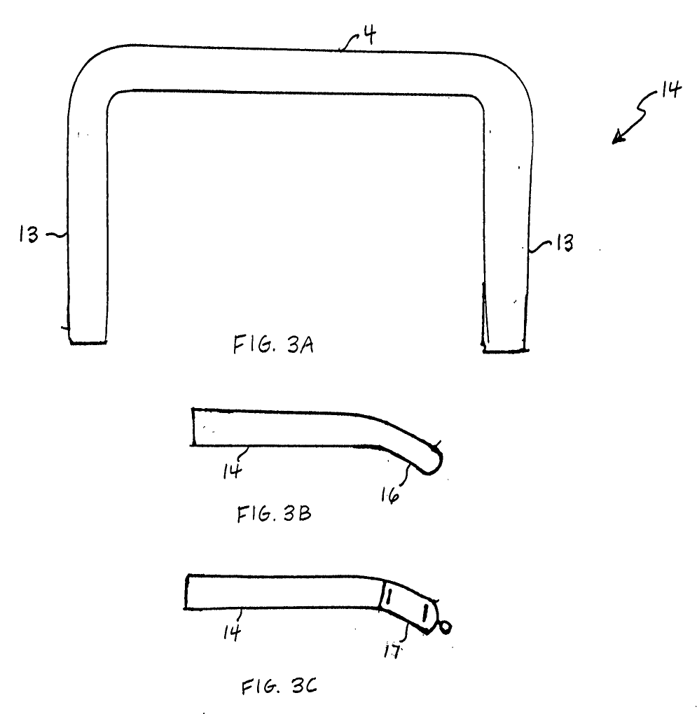

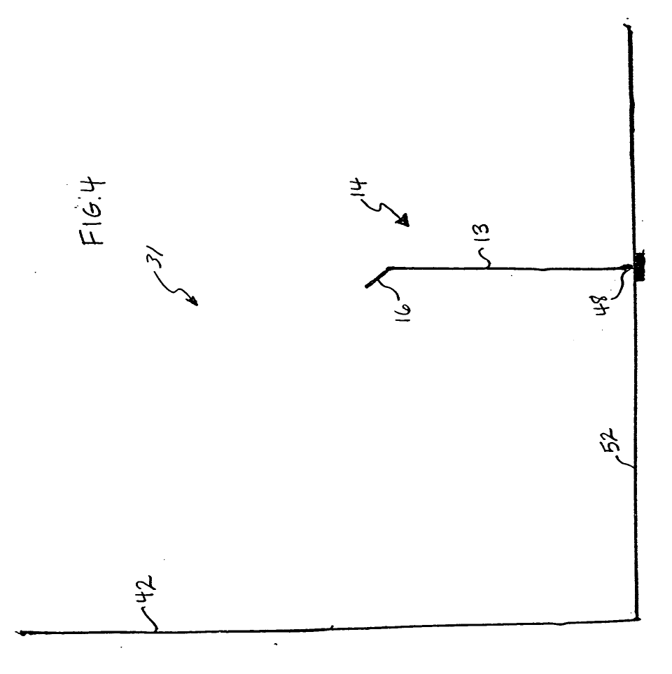

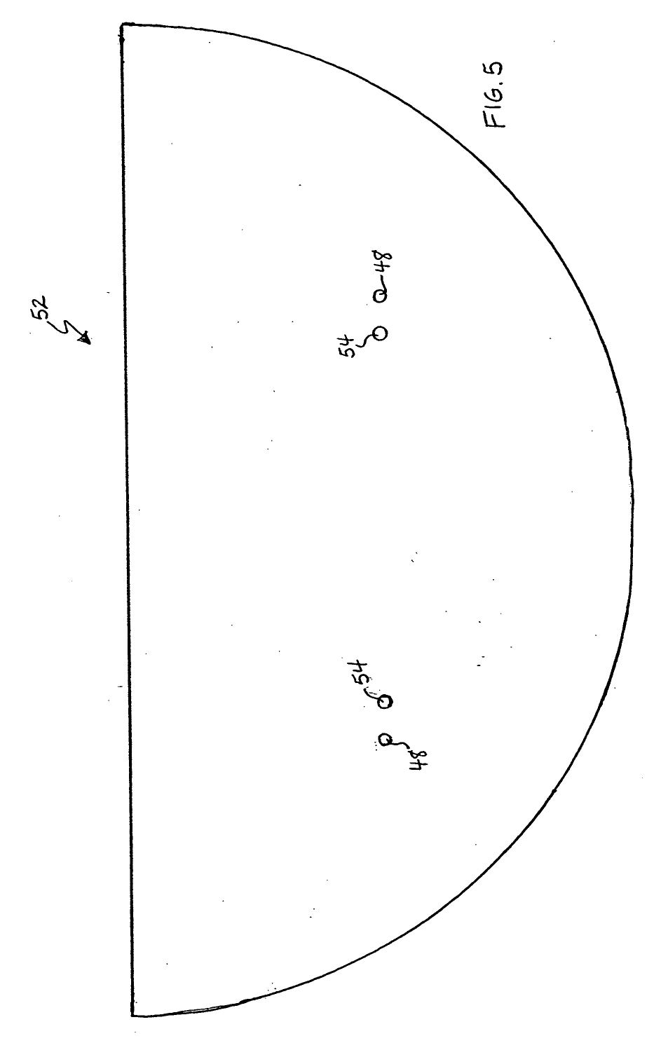

FIGS. 4 and 5 illustrate a pet securing floor model 31. A metal silhouette 42 that is attached to base 52. Base 52 is where the bar 14 is secured through holes 48. Referring to FIG. 5, a topographic view of the base 52 used for floor models is shown. The base 52 is where a silhouette 42 is attached to as well as the piece that is secured to floors. Holes 48 are where the dog bar 14 found in FIG. 3A, is attached to base 52. Holes 54 are used by screws to attach the pet securing system 31 to wall or floor.

FIGS. 3A and 3B are representative of the bar 14 used to secure pets. FIG. 3A is drawing of the two ninety degree angles with the middle section 4 and two legs 13. FIG. 3B is a side view of the bar 14 that shows the design of the bend 16 in the bar 14 for easy anchoring purposes. FIG. 3C is a side view of a bar 14 that has a enclosed retractable leash 17. The retractable leash 17 allows individuals to use the bars leash as opposed to their own personal leashes. The locking system used in the retractable leash is a variety of clasps, hooks, swivels, or other attaching devices. Retractable leash 17 also represents hooking devices that are not retractable, like a carabineer, but are otherwise used for securing pets.

The various models of the pet securing device are designed to be lightweight, durable, and strong. The system allows individuals to easily incorporate their pets in their daily activities by allowing them freedom to take their pets to various locations with the assurance of a secured place to tie their pet while they shop, eat, or merely visit.

From the information given it is apparent that various variations of the pet securing system mentioned above can be developed from this pet securing inventions spirit. However, it is noted that the embodiment of the pet securing device variations described herein in detail, for explanation, is open to different variations in structure, design, application, and methodology. Because many different variations can be made within the scope/spirit of the inventive concept(s) herein explained, and because many modifications may be made in the embodiment herein detailed in accordance with descriptive requirements of the law, its to be understood that the details herein are to be interpreted as illustrative and not in a limiting sense. And modified forms of the present invention done by others skilled in the art to which the invention pertains will be considered infringements of this invention when whose modified forms fall within the claimed scope of this invention.

Although the invention has been described in detail with reference to certain illustrated embodiments, variations and modifications exist within the scope and spirit of the invention as described and as defined in the following claims.

1-8. (canceled).

9. (New) A pet securing device configured to couple to one of a horizontal surface and a vertical surface, the pet-securing device comprising:
a frame including first and second portions, the first portion defining a perimeter, the perimeter generally shaped like an animal; and
a bar coupled to the frame, the bar extending from the frame and configured to receive a leash.

10. (New) The pet securing device of claim 9, wherein the perimeter is generally shaped like a dog.

11. (New) The pet securing device of claim 9, wherein the frame defines a first plane and the first and second portions lie in the first plane.

12. (New) The pet securing device of claim 9, wherein the first portion is positioned in a substantially vertical plane and the second portion is positioned in a substantially horizontal plane.

13. (New) The pet securing device of claim 12, wherein the second portion includes a plurality of apertures configured to receive a plurality of fasteners configured to couple the second portion to one of the horizontal and vertical surfaces.

14. (New) The pet securing device of claim 12, wherein the bar is coupled to the second portion.

15. (New) The pet securing device of claim 12, wherein the second portion of the frame includes a generally semi-circularly shaped perimeter.

16. (New) The pet securing device of claim 9, wherein the bar includes first and second ends configured to receive one of a pair of fasteners, each of the pair of fasteners configured to extend through apertures in the frame to couple the ends of the bar to the frame.

17. (New) The pet securing device of claim 9, wherein the bar is substantially U-shaped.

18. (New) The pet securing device of claim 17, wherein the bar includes a pair of leg portions including first and second ends and a middle portion, the first end of the leg portions coupled to the frame, the second end of each leg portion including a curved portion, the curved portion coupled to the middle portion.

19. (New) The pet securing device of claim 9, further comprising a retractable leash coupled to the frame.

20. (New) A pet securing device configured to couple to one of a horizontal surface and a vertical surface, the pet-securing device comprising:
a frame including first and second portions, the first portion defining a perimeter, the perimeter generally shaped like an animal, the frame including a plurality of apertures, at least a pair of the plurality of apertures configured to accept a first pair of fasteners configured to couple the frame to one of the horizontal and the vertical surface; and
a U-shaped bar extending from the frame and configured to receive a leash, the U-shaped portion including two leg portions and a middle portion, each leg portion including a first and second end, the first end of each leg portion including a curved portion configured to couple to the middle portion, the second end of each leg portion configured to receive one of a second pair of fasteners, each fastener of the second pair of fasteners configured to extend though one of the plurality of apertures in the frame and couple to the leg portions.

21. (New) The pet-securing device of claim 20, wherein the leg portions extend from the frame at about a 90 degree angle.

22. (New) A pet-securing device configured to couple to one of a horizontal surface and a vertical surface, the pet-securing device comprising:
a frame including first and second portions, the frame including a plurality of apertures, at least a pair of the plurality of apertures configured to receive a first pair of fasteners configured to couple the frame to one of the horizontal and the vertical surfaces; and
a bar extending from the frame and configured to receive a leash, the bar including first and second ends, each end of the bar coupled to the frame at a position immediately adjacent the to each of the first pair of fasteners.

23. (New) The pet securing device of claim 22, wherein the first and second portions of the frame are coupled together at about a 90 degree angle, the first portion being substantially vertical, the second portion being substantially horizontal.

24. (New) The pet securing device of claim 23, wherein the bar is coupled to the second portion and the second portion includes the plurality of apertures.

25. (New) The pet securing device of claim 23, wherein the bar is spaced apart from the first portion of the frame.

26. (New) The pet securing device of claim 23, wherein the first portion of the frame includes a generally animal shaped perimeter.

27. (New) The pet securing device of claim 22, wherein the frame includes a generally animal shaped perimeter.

28. (New) The pet securing device of claim 22, wherein the first and second ends of the bar are configured to receive one of a second pair of fasteners, each of the second pair of fasteners configured to extend through a pair of apertures in the first portion to couple the ends of the bar to the frame.
